(19) United States
(12) Patent Application Publication
(10) Pub. No.: US 2009/0162483 A1
(43) Pub. Date: Jun. 25, 2009

(54) SPORTS BEVERAGE AND METHOD OF MAKING

(76) Inventors: Wendy Lynn Constantine, Weston, CT (US); Altalee Stacey Ann Dixon, Brookfield, CT (US); Steven Kramer, Monroe, CT (US); Margaret Watkins Varhol, Prospect, CT (US)

Correspondence Address: CANTOR COLBURN, LLP, 20 Church Street, 22nd Floor, Hartford, CT, 06103, US

(21) Appl. No.: 12/337,787

(22) Filed: Dec. 18, 2008

Related U.S. Application Data
(60) Provisional application No. 61/015,439, filed on Dec. 20, 2007.

(51) Int. Cl. A23L 2/00; A23L 2/56; A23L 2/60; A23L 2/66

(52) U.S. Cl. 426/62; 426/590; 426/73; 426/74; 426/89

(57) ABSTRACT

Disclosed herein are sports beverage compositions in liquid drink form for optimizing muscle performance during exercise. The composition is formulated to contain an acid component and a flavor package that minimize off flavors and dry mouthfeel imparted by elevated levels of protein used in the beverage.

### CROSS REFERENCE TO RELATED APPLICATION

This application claims the benefit of U.S. Provisional Application Ser. No. 61/015,439 filed Dec. 20, 2007, which is hereby incorporated by reference in its entirety.

### FIELD

The present invention relates to a sports beverage composition.

### BACKGROUND

Over the past thirty years, there has been extensive research conducted on the role hydration and carbohydrate supplementation play in improving exercise performance. This research led to the development of sports drinks that contain carbohydrate in the range of 6-8%, as well as electrolytes such as sodium, potassium, magnesium and chloride. Numerous studies have shown that consumption of a sports drink during exercise containing carbohydrate and electrolytes enables athletes to extend their endurance capacity to a greater extent than by the consumption of water alone.

When a sports drink is consumed during exercise, the carbohydrate is transported from the blood into the muscle where it then can be converted into energy. Normally, glucose uptake is controlled by insulin. However, during periods of intense activity there is a decrease in the production of insulin and glucose is transported into the muscle primarily by the contraction of the muscle cell. The uptake of glucose into the muscle is critical to preserve muscle glycogen. To the degree that muscle glycogen is preserved, there is an enhancement in endurance capacity since more muscle glycogen is then available in the later stages of exercise.

It has been shown that when insulin is stimulated during intense exercise there is greater uptake of glucose. Increasing carbohydrate consumption during exercise can stimulate insulin up to a point. When high levels of carbohydrate are consumed during exercise, however, they do not empty the stomach rapidly, so carbohydrate intake becomes rate limiting in its ability to stimulate insulin.

Previously, it has been shown that when protein is added to a source of carbohydrate, it can provide enhanced stimulation of insulin. Protein has been shown to slow gastric emptying. U.S. Pat. No. 6,207,638 disclosed that when protein is added to carbohydrate in a 4 to 1 ratio, insulin stimulation is increased and the synthesis of muscle glycogen is enhanced with no negative impact on rehydration following exercise.

Use of increasingly high levels of protein in a beverage leads to a drink having a variety of undesirable organoleptic properties. The high levels of protein often results in a drying mouthfeel. Furthermore, use of whey protein imparts unpleasant dairy off-notes (e.g., sour milk) or sulfur off-notes.

There remains a need in the art for a sports drink that will increase the uptake of glucose during exercise, while at the same time providing a beverage with a pleasing taste profile and mouthfeel for consumer acceptance.

### SUMMARY

Disclosed herein is a sports beverage composition comprises water; a saccharide sweetener; about 2.2 to about 3.5 weight percent of a protein based on the total weight of the composition; about 0.001 to about 0.200 weight percent lactic acid based on the total weight of the composition; phosphoric acid; and a flavoring agent.

In another embodiment, a sports beverage composition comprises water; a saccharide sweetener; about 2.2 to about 3.5 weight percent of a protein based on the total weight of the composition; an orange flavor note; and a flavoring agent.

In yet another embodiment, a sports beverage composition comprises water; trehalose; about 2.2 to about 3.5 weight percent of a whey protein isolate based on the total weight of the composition; about 0.001 to about 0.200 weight percent lactic acid based on the total weight of the composition; phosphoric acid; optionally a flavoring agent further comprising an orange flavor note; and optionally a dairy masking agent or a bitter masking agent.

In still yet another embodiment, a sports beverage composition comprises water; medium invert sugar; trehalose; about 2.2 to about 3.5 weight percent of a whey protein isolate based on the total weight of the composition; about 0.001 to about 0.200 weight percent lactic acid based on the total weight of the composition; phosphoric acid; magnesium carbonate; monopotassium phosphate; sodium chloride; citric acid; sodium ascorbate; vitamin E acetate; and a flavoring agent having a character flavor of tropical fruit, grapefruit, dark berry, peach, or fruit punch; optionally the flavoring agent further comprises an orange flavor note; and optionally a dairy masking agent or a bitter masking agent.

The above described and other features are exemplified by the following figures and detailed description.

### DETAILED DESCRIPTION

Disclosed herein are sports beverage compositions for optimizing muscle performance during exercise where the beverage has pleasing organoleptic properties. The beverage compositions contain high amounts of a protein, a sweetening agent, a micronutrient such as vitamins C and E for use as an antioxidant for preventing free radical formation during exercise, electrolytes for replenishing electrolytes lost during exercise and for facilitating intestinal reabsorption of fluids or for facilitating energy dependent processes. It has been surprisingly found that the use of low levels of lactic acid and increased levels of phosphoric acid provides a sports beverage composition containing large amounts of protein with minimized or no drying mouthfeel or no sulfur sour milk notes. The phosphoric acid provides a desirable tartness to the beverage composition as well as providing a targeted pH level to maintain the stability of the protein in the composition.

Use of certain flavoring agents will also prevent a drying mouthfeel or provide taste masking for unpleasant dairy off-notes (e.g., sour milk) or sulfur off-notes. It has been surprisingly found that the use of an orange flavor note decreased the dairy/sulfur off-note and reduced the drying mouthfeel. Such a result was unexpected as use of orange as the characteristic flavor exacerbated the off-flavor and drying mouthfeel problems in a sports beverage. The term “flavor note” as used herein means a flavor that contributes to the overall flavor, but is not the characteristic or central flavor. The term “characteristic flavor” as used herein means a flavor that imparts the distinguishing flavor and which contributes most to the perceived flavor.

It has also been surprisingly found that the use of complementary character flavors in the sports beverage composition minimized the dairy off-notes (e.g., sour milk) or sulfur off-notes. For example, grapefruit flavor exhibits a sulfur note. Use of a grapefruit flavor imparts a complementary flavor to any sulfur notes imparted by the dairy protein for example, thus masking the dairy off-note. A dairy masking agent can be used to add creaminess to the flavor profile and which complements the dairy note of the dairy protein resulting in a more pleasing taste profile for the sports beverage composition.

Other approaches for improving the organoleptic properties of the sports beverage composition include use of high-intensity sweeteners, use of sensates, or encapsulation of the protein. Each additional approach is described further herein.

The term “beverage” as used herein means any drinkable liquid or semi-liquid, including for example flavored water, soft drinks, fruit drinks, coffee-based drinks, tea-based drinks, juice-based drinks, milk-based drinks, gel drinks, carbonated or non-carbonated drinks, alcoholic or non-alcoholic drinks.

The term “beverage concentrate” or “beverage base” as used herein means an intermediate beverage product which, when mixed with a sweetening agent and an appropriate amount of water or other suitable liquid or semi-liquid, forms a beverage syrup or alternatively a beverage. The beverage concentrate generally comprises a flavoring agent and optional additives.

The term “beverage syrup” as used herein means an intermediate beverage product prepared from a beverage concentrate, a sweetening agent, and an amount of water or other suitable liquid or semi-liquid. The beverage syrup is in a concentrated form that can be diluted to form a beverage. The beverage syrup generally comprises a flavoring agent, a sweetening agent, and optional additives such as food-grade acids, coloring agents, and the like.

The term “flavor key” as used herein is a flavor component containing flavoring agents such as flavored oils, and the like, and is typically used to prepare a flavor essence.

The term “flavor essence” (“flavor blend”, “flavor extract”) as used herein is a flavor component generally prepared from a flavor key.

The term “food-grade acid,” as used herein, encompasses any acid that is acceptable for use in edible compositions.

The sports beverage compositions disclosed herein provide for nutritional compositions for optimizing muscle performance during exercise; compositions that will speed the uptake of glucose into the muscle cells during exercise; compositions that will increase the efficiency of every gram of every carbohydrate consumed during exercise; compositions that will restore fluid and electrolytes, for replenishing glycogen stores in the muscle, and for reducing oxidative and muscle stress; compositions to speed the uptake of glycogen into the muscle thereby sparing muscle glycogen stores and extending endurance; compositions that restore fluid and electrolyte levels that are depleted during exercise; and compositions that reduce oxidative stress by preventing the buildup of free radicals that form as a consequence of exercise.

The compositions described herein can contain a portion of added water. As used herein “added water” does not include water incidentally added to the composition through other components such as milk or a fruit juice component, for example. The beverage compositions can contain up to about 99 weight percent (wt %) added water based on the total weight of the composition, specifically about 0.1 to about 98 wt %, more specifically about 1.0 to about 95 wt %, and yet more specifically about 5.0 to about 90 wt % added water each based on the total weight of the composition.

The added water is specifically purified or treated prior to use using processes well-known in the art such as filtration, deionization, distillation, or reverse osmosis.

The sports beverage composition generally comprises an amount of protein. The protein is provided in the beverage to be used as a source of stimulation of insulin during exercise. The protein can be from a variety of sources including meat proteins, dairy proteins, vegetable proteins, or other proteins. Exemplary meat proteins include meat protein concentrate. Exemplary dairy proteins include calcium caseinate, sodium caseinate, whey protein, whey protein concentrate, whey protein isolate, whey protein hydrolyzate, demineralized whey protein, milk protein, casein hydrolyzate, or a combination comprising at least one of the foregoing proteins. An exemplary milk protein is the spray-dried combination of whey protein isolate and trehalose available from Cargill under the name BT-100. Exemplary vegetable proteins include soy protein, soy protein isolate, soy protein concentrate, pea protein, rice protein, soy flour, rice protein, wheat protein, corn protein, nut protein, or a combination comprising at least one of the foregoing proteins. Exemplary other proteins include egg albumin, yeast concentrate, or a combination comprising at least one of the foregoing proteins.

The protein is generally present in the sports beverage composition in an amount of about 1.0 to about 10 weight percent, specifically about 2.0 to about 7.0 weight percent, and yet more specifically about 3.0 to about 5.0 weight percent based on the total weight of the composition. When using dairy protein, the dairy protein is present in the sports beverage composition in an amount of about 2.2 to about 3.5 weight percent, specifically about 2.5 to about 3.2 weight percent, and yet more specifically about 2.8 to about 2.9 weight percent based on the total weight of the composition.

Flavoring agents can be included in the compositions. Flavoring agents include those flavors known to one of ordinary skill in the art, such as natural flavors, artificial flavors, spices, seasonings, and the like. Specific flavoring agents for use in the sports beverage composition include those flavoring agents that can impart a complementary character flavor to the off-notes provided by the dairy protein. Specifically, use of a tropical fruit flavor (e.g., grapefruit flavor) which has a sulfur note can be used to complement the sulfur off-note of the dairy protein.

In one embodiment, the sports beverage composition is free of benzaldehyde flavor (almond flavor at low levels and cherry flavor at high levels), and orange flavor as the character flavor.

In another embodiment, the sports beverage composition comprises a grapefruit flavor, a peach flavor, a dark berry flavor, or a fruit punch flavor.

In yet another embodiment, the sports beverage composition comprises an orange flavor note. The orange flavor note can be low in orange terpenes.

Exemplary flavoring agents include synthetic flavor oils and flavoring aromatics and/or oils, oleoresins, essences, distillates, and extracts derived from plants, leaves, flowers, fruits, and so forth, and a combination comprising at least one of the foregoing.

Exemplary flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents include artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, prune, raisin, cola, guarana, neroli, pineapple, apricot, banana, melon, apricot, ume, cherry, raspberry, blackberry, tropical fruit, mango, mangosteen, pomegranate, papaya and so forth. Additional exemplary flavors imparted by a flavoring agent include a milk flavor, a butter flavor, a cheese flavor, a cream flavor, and a yogurt flavor; a vanilla flavor; tea or coffee flavors, such as a green tea flavor, an oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a camomile flavor, a mustard flavor, a cardamon flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; a nut flavor such as an almond flavor, a hazelnut flavor, a macadamia nut flavor, a peanut flavor, a pecan flavor, a pistachio flavor, and a walnut flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor.

In some embodiments, other flavoring agents include aldehydes and esters such as cinnamyl acetate, cinnamaldehyde, citral diethylacetal, dihydrocarvyl acetate, eugenyl formate, p-methylamisol, and so forth can be used. Further examples of aldehyde flavorings include acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), and the like. Generally any flavoring or food additive such as those described in Chemicals Used in Food Processing, publication 1274, pages 63-258, by the National Academy of Sciences, can be used. This publication is incorporated herein by reference.

The flavoring agents can be used in liquid or solid/dried form and can be used individually or in admixture. When employed in dried form, suitable drying means such as spray drying an oil can be used. Alternatively, the flavoring agent is absorbed onto water-soluble materials, such as cellulose, starch, sugar, maltodextrin, gum arabic and so forth or can be encapsulated. In still other embodiments, the flavoring agent is adsorbed onto silicas, zeolites, and the like. The techniques for preparing such dried forms are well-known.

In some embodiments, the flavoring agents are used in many distinct physical forms. Without being limited thereto, such physical forms include free forms, such as spray dried, powdered, beaded forms, encapsulated forms, emulsions such as caramel or gum arabic emulsions, and a combination comprising at least one of the foregoing physical forms.

The particular amount of the flavoring agent effective for imparting flavor characteristics to the composition will depend upon several factors including the flavor, the flavor impression, and the like.

Suitable amounts of the flavoring agent can be selected by one of ordinary skill in the art without undue experimentation using guidelines provided. In one embodiment, the flavoring agent can be present in a beverage composition from about 0.1 to about 8.0 wt % based on the total weight of the beverage composition, specifically about 0.4 to about 6 wt %, and more specifically about 1.0 to about 3.0 wt % each based on the total weight of the beverage composition.

The flavoring agent may additionally contain weighting agents, emulsifiers, emulsion stabilizers, antioxidants, liquid vehicles, and the like.

The term “weighting agent” as used herein means any material used to adjust the specific gravity of a material whose specific gravity is lighter or lower than the specific gravity of water. In some embodiments, flavoring agents with specific gravities lower that the specific gravity of water are combined with weighting agents. Without adjusting the specific gravity of such flavoring agents or other materials with specific gravities lower than water, they may rise to the upper surface of the beverage composition. Weighting agents can include, but are not limited to brominated vegetable oil, ester gums, SAIB (sucrose acetate isobutyrate), and a combination comprising at least one of the foregoing.

Other approaches to prevent or delay materials with specific gravities lower than the specific gravity of water from rising to the upper surface of a beverage composition can be to increase the viscosity of the beverage composition or to reduce the particle size of the material with the lower specific gravity. Thus, in some embodiments, flavoring agents without weighting agents remain stable in a beverage composition.

The compositions can also contain, in addition to a flavoring agent, a flavor potentiator. Flavor potentiators are materials that can intensify, supplement, modify or enhance the taste and/or aroma perception of a composition without introducing a characteristic taste and/or aroma perception of their own. In some embodiments, potentiators designed to intensity, supplement, modify, or enhance the perception of flavor, sweetness, tartness, umami, kokumi, saltiness, and a combination comprising at least one of the foregoing.

In some embodiments, examples of suitable potentiators, also known as taste potentiators include neohesperidin dihydrochalcone, chlorogenic acid, alapyridaine, cynarin, miraculin, glupyridaine, pyridinium-betain compounds, glutamates, such as monosodium glutamate and monopotassium glutamate, neotame, thaumatin, tagatose, trehalose, salts, such as sodium chloride, monoammonium glycyrrhizinate, vanilla extract (in ethyl alcohol), sugar acids, potassium chloride, sodium acid sulfate, hydrolyzed vegetable proteins, hydrolyzed animal proteins, yeast extracts, adenosine monophosphate (AMP), glutathione, nucleotides, such as inosine monophosphate, disodium inosinate, xanthosine monophosphate, guanylate monophosphate, alapyridaine (N-(1-carboxyethyl)-6-(hydroxymethyl)pyridinium-3-ol inner salt), sugar beet extract (alcoholic extract), sugarcane leaf essence (alcoholic extract), curculin, strogin, mabinlin, gymnemic acid, hydroxybenzoic acids, 3-hydrobenzoic acid, 2,4-dihydrobenzoic acid, citrus aurantium, vanilla oleoresin, sugarcane leaf essence, maltol, ethyl maltol, vanillin, licorice glycyrrhizinates, compounds that respond to G-protein coupled receptors (T2Rs and T1Rs), G-protein coupled receptors (T2Rs and T1Rs), and taste potentiator compositions that impart kokumi, as disclosed in U.S. Pat. No. 5,679,397 to Kuroda et al., which is incorporated in its entirety herein by reference, and a combination comprising at least one of the foregoing potentiators. “Kokumi” refers to materials that impart “mouthfulness” and “good body”.

Sweetener potentiators, which are a type of taste potentiator, enhance the taste of sweetness. In some embodiments, exemplary sweetener potentiators include, monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, sugar beet extract, neotame, thaumatin, neohesperidin dihydrochalcone, hydroxybenzoic acids, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs), G-protein coupled receptors (T2Rs and T1Rs), hydroxybenzoic acid amides as disclosed in WO 2006/024587 to Ley et al., which is incorporated in its entirety herein by reference, hydroxydeoxybenzoins (i.e. hydroxyl-substituted 1,2-diphenylethanones) as disclosed in WO2006/106023 to Ley et al., which is incorporated in its entirety herein by reference, and a combination comprising at least one of the foregoing potentiators.

Additional examples of potentiators for the enhancement of salt taste include acidic peptides, such as those disclosed in U.S. Pat. No. 6,974,597, herein incorporated by reference. Acidic peptides include peptides having a larger number of acidic amino acids, such as aspartic acid and glutamic acid, than basic amino acids, such as lysine, arginine and histidine. The acidic peptides are obtained by peptide synthesis or by subjecting proteins to hydrolysis using endopeptidase, and if necessary, to deamidation. Suitable proteins for use in the production of the acidic peptides or the peptides obtained by subjecting a protein to hydrolysis and deamidation include plant proteins, (e.g. wheat gluten, corn protein (e.g., zein and gluten meal), soybean protein isolate), animal proteins (e.g., milk proteins such as milk casein and milk whey protein, muscle proteins such as meat protein and fish meat protein, egg white protein and collagen), and microbial proteins (e.g., microbial cell protein and polypeptides produced by microorganisms).

A dairy masking agent can be used to add creaminess to the flavor profile and which complements the dairy note of the dairy protein resulting in a more pleasing taste profile for the sports beverage composition. In addition, a bitter masking agent can be used.

Some embodiments also may include a sweetening agent to provide a sweet taste to the composition. Sweetening agents may include sugar sweeteners, sugarless sweeteners, and a combination comprising at least one of the foregoing.

Sugar sweeteners generally include saccharides. Suitable sugar sweeteners include mono-saccharides, di-saccharides and poly-saccharides such as sucrose (sugar), dextrose, maltose, dextrin, xylose, ribose, glucose, mannose, galactose, fructose (levulose), lactose, invert sugar, fructo oligo saccharide syrups, partially hydrolyzed starch, trehalose, tagatose, corn syrup solids, such as high fructose corn syrup, and a combination comprising at least one of the foregoing.

Suitable sugarless sweetening agents for use in the concentrate include sugar alcohols (or polyols), such as glycerol, sorbitol, xylitol, mannitol, galactitol, maltitol, hydrogenated isomaltulose (isomalt), lactitol, erythritol, hydrogenated starch hydrolysate, polyglycitol (e.g,. syrup or powder), stevia and a combination comprising at least one of the foregoing.

Suitable hydrogenated starch hydrolysates include those disclosed in U.S. Pat. Nos. 25,959, 3,356,811, 4,279,931 and various hydrogenated glucose syrups and/or powders which contain sorbitol, hydrogenated disaccharides, hydrogenated higher polysaccharides, and a combination comprising at least one of the foregoing. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN™, a line of commercially available products manufactured by Roquette Freres of France, and HYSTAR™, a line of commercially available products manufactured by Lonza, Inc., of Fairlawn, N.J., also may be useful.

In some embodiments, the sweetening agent is present in amounts of about 0.01 to about 25 wt % based on the total weight of the composition, specifically about 0.1 to about 15 wt %, more specifically 1.0 to about 10 wt %, and yet more specifically 2.0 to about 5.0 wt % each based on the total weight of the composition.

Some embodiments may include high-intensity sweeteners in the composition. Without being limited to particular sweeteners, representative categories and examples include:

(a) water-soluble sweetening agents such as dihydrochalcones, monellin, steviosides, glycyrrhizin, dihydroflavenol, and sugar alcohols such as sorbitol, mannitol, maltitol, and L-aminodicarboxylic acid aminoalkenoic acid ester amides, such as those disclosed in U.S. Pat. No. 4,619,834, which disclosure is incorporated herein by reference, and a combination comprising at least one of the foregoing;

(b) water-soluble artificial sweeteners such as soluble saccharin salts, i.e., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and a combination comprising at least one of the foregoing;

(c) dipeptide based sweeteners, such as L-aspartic acid derived sweeteners, such as L-aspartyl-L-phenylalanine methyl ester (Aspartame) and materials described in U.S. Pat. No. 3,492,131, L-alphaaspartyl-N-(2,2,4,4-tetramethyl-3-thietanyl)-D-alaninamide hydrate (Alitame), N-[N-(3,3-dimethylbutyl)-L-aspartyl]-L-phenylalanine 1-methyl ester (Neotame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, and a combination comprising at least one of the foregoing;

(d) water-soluble sweeteners derived from naturally occurring water-soluble sweeteners, such as chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-furanoside, or 4,1′-dichloro-4,1′-dideoxygalactosucrose; 1′,6′-dichloro 1′,6′dideoxysucrose; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideox y-beta-D-fructofuranoside, or 4,6,1′,6′-tetrachloro4,6,1′,6′-tetradeoxygalacto-sucrose; and 4,6,1′,6′-tetradeoxy-sucrose, and a combination comprising at least one of the foregoing;

(e) protein based sweeteners such as thaumaoccous danielli (Thaumatin I and II); and

(f) the naturally occurring sweetener monatin (2-hydroxy-2-(indol-3-ylmethyl)-4-aminoglutaric acid) and its derivatives, or lo han quo and its derivatives.

Many sweetening agents, including some previously discussed, can be categorized as natural sweeteners, for example L-alanine, arabinose, banana extract, carob, cellobiose, corn syrup (including high fructose corn syrup and corn syrup solids), dextrin, dextrose, Dioscoreophyllum cumminsii (Serendipity Berry), erythritol, fructooligosaccharide (FOS), fructose, (including “liquid fructose”), galactose, glucose, glycine, glycyrrhizin, honey, inulin, isomalt, invert sugar, lactitol, lactose, lo han (lo han kuo; lo han guo; lohan guo; lohan kuo), maltitol, maltodextrin, maltose, mannitol, mannose, monatin, maple syrup, molasses, partially hydrogenated starch hydrolysate, partially hydrolyzed starch, polydextrose solution, polyglycitol, raftilose, miraculin (Richa[r]della dulcifica (Miracle Berry)), ribose, rice syrup, sorbitol, sorbose, stevia, stevioside, sucralose, sucrose, sugar beets, (dehydrated filaments of), D-tagatose, thaumatin, xylitol, xylose, and a combination comprising at least one of the foregoing.

The sweetening agent can be used individually or as mixtures.

The sweetening agents can be used in many distinct physical forms well-known in the art to provide an initial burst of sweetness and/or a prolonged sensation of sweetness. Without being limited thereto, such physical forms include free forms, such as spray dried, powdered, beaded forms, encapsulated forms, and a combination comprising at least one of the foregoing. In general, an effective amount of sweetener can be utilized to provide the level of sweetness desired, and this amount may vary with the sweetener selected. Suitable amounts for each type of sweetener can be selected by one of ordinary skill in the art without undue experimentation.

In some embodiments, the composition may include optional additives such as antioxidants, amino acids, caffeine, coloring agents (“colorants”, “colorings”), emulsifiers, flavor potentiators, food-grade acids, minerals, micronutrients, plant extracts, phytochemicals (“phytonutrients”), preservatives, salts including buffering salts, stabilizers, thickening agents, medicaments, vitamins, and a combination comprising at least one of the foregoing additives. Those of ordinary skill in the art will appreciate that certain additives may meet the definition or function according to more than one of the above-listed additive categories.

Suitable salts for use in the composition include, alkali or alkaline earth metal chlorides, glutamates, and the like. For example, monosodium glutamate, potassium chloride, sodium chloride, and a combination comprising at least one of the foregoing salts. The salts can be added to the beverage as a flavor potentiator as previously described. The salts can also be added the sports beverage composition to provide the desired electrolytes such as sodium, potassium, magnesium and chloride. The electrolytes can be added to the sports beverage composition as a means for replenishing electrolytes lost during exercise and for facilitating intestinal reabsorption of fluid.

The sodium (Na⁺) electrolyte may be in the form of sodium chloride, sodium acetate, sodium citrate, sodium phosphate, sodium bicarbonate, sodium bromide, sodium citrate, sodium lactate, sodium phosphate, sodium sulphate, sodium tartrate, sodium benzoate, sodium selenite, and the like or a combination comprising at least one of the foregoing sodium salts.

The potassium (K⁺) electrolyte may be in the form of potassium chloride, potassium acetate, potassium bicarbonate, potassium bromide, potassium citrate, potassium-D-gluconate, monobasic potassium phosphate, potassium tartrate, potassium sorbate, potassium iodide, and the like or a combination comprising at least one of the foregoing sodium salts.

The magnesium (Mg⁺²) electrolyte may be in the form of magnesium chloride, magnesium oxide, magnesium sulphate, magnesium carbonate, magnesium aspartate, magnesium silicate and the like or a combination comprising at least one of the foregoing sodium salts.

Suitable food-grade acids for use in the composition include, for example, acetic acid, adipic acid, ascorbic acid, butyric acid, citric acid, formic acid, fumaric acid, glyconic acid, lactic acid, malic acid, phosphoric acid, oxalic acid, succinic acid, tartaric acid, and a combination comprising at least one of the foregoing food-grade acids. The food-grade acid can be added as acidulant to control the pH of the beverage and also to provide some preservative properties; or to stabilize the beverage.

As mentioned previously, by using reduced amounts of lactic acid and substituting with phosphoric acid in the sports beverage composition a desired pH and acidity can be achieved for protein stability and taste. The reduced level of lactic acid also allows for the reduction in drying mouthfeel and sulfur, sour milk notes encountered with other dairy protein containing sports drinks containing higher amounts of lactic acid.

In one embodiment, the amount of lactic acid can be about 0.001 to about 0.200 weight percent, specifically about 0.006 to about 0.120 weight percent, and more specifically about 0.010 to about 0.080 weight percent based on the total weight of the beverage composition.

The pH of the beverage may also be modified by the addition of food-grade compounds such as ammonium hydroxide, sodium carbonate, potassium carbonate, sodium bicarbonate, and the like, and a combination comprising at least one of the foregoing. Additionally, the pH of the beverage can be adjusted by the addition of carbon dioxide. Further, in some embodiments, buffering agents including, but not limited to citrates such as sodium citrate, can be used to adjust the pH of the beverage.

To maintain the stability of the protein, the pH of the sports beverage composition is maintained at or below 3.5. Higher pH of the composition results in precipitation of the protein from the beverage solution. The pH of the sports beverage composition can be about 2.0 to about 3.5, specifically about 2.3 to about 3.3, and yet more specifically about 2.8 to about 3.0.

In some embodiments, the tartness of the composition may be varied by selecting and combining acids to provide a desired tartness perception. Some factors to consider in determining a desired tartness include, for example, the acid's dissociation constant, solubility, pH, etc. These variables can be measured by measuring the titratable acidity of the beverage composition. Tartness can also be measures by standard sensory science techniques such as those described by H. Moskowitz in Sourness of Acid Mixtures as published in The Journal of Experimental Psychology, April 1974; 102(4); 640-7 and in Ration Scales of Acid Sourness as published in Perception and Psychophysics; 9:371-374, 1971.

To provide a desired tartness to the sports beverage composition, the titratable acidity of the composition can be about 0.3 to about 0.7 g/100 g, specifically about 0.4 to about 0.6, and more specifically about 0.48 to about 0.51 g/100 g.

Coloring agents can be used in amounts effective to produce a desired color for the composition. The colorants may include pigments, natural food colors and dyes suitable for food, drug and cosmetic applications. A full recitation of all F.D.& C. colorants and their corresponding chemical structures can be found in the Kirk-Othmer Encyclopedia of Chemical Technology, 3rd Edition, in volume 5 at pages 857-884, of which text is incorporated herein by reference.

As classified by the United States Food, Drug, and Cosmetic Act (21 C.F.R. 73), colors can include exempt from certification colors (sometimes referred to as natural even though they can be synthetically manufactured) and certified colors (sometimes referred to as artificial), and a combination comprising at least one of the foregoing. In some embodiments, exemplary exempt from certification or natural colors can include, annatto extract, (E160b), bixin, norbixin, astaxanthin, dehydrated beets (beet powder), beetroot red/betanin (E162), ultramarine blue, caramel color (E150a), canthaxanthin (E161g), cryptoxanthin (E161c), rubixanthin (E161d), violanxanthin (E161e), rhodoxanthin (E161f), caramel (E150(a-d)), β-apo-8′-carotenal (E160e), P-carotene (E160a), alpha carotene, gamma carotene, ethyl ester of beta-apo-8 carotenal (E160f), flavoxanthin (E161a), lutein (E161b), cochineal extract (E120); carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), and a combination comprising at least one of the foregoing.

In some embodiments, exemplary certified colors can include FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminium (E173), silver (E174), gold (E175), pigment rubine/lithol rubine BK (E180), calcium carbonate (E170), carbon black (E153), black PN/brilliant black BN (E151), green S/acid brilliant green BS (E142), and a combination comprising at least one of the foregoing. In some embodiments, certified colors can include FD&C aluminum lakes. These consist of the aluminum salts of FD&C dyes extended on an insoluble substrate of alumina hydrate. Additionally, in some embodiments, certified colors can be included as calcium salts.

Acceptable coloring agents are specifically water-soluble coloring agents.

Suitable amounts of colorant to provide the desired visual effect can be selected by one of ordinary skill in the art without undue experimentation using guidelines provided. Exemplary amounts of coloring agents can be about 0.005 to about 15 wt %, specifically about 0.01 to about 6 wt %, and more specifically about 0.1 to about 2 wt % each based on the total weight of the composition.

Emulsifiers can be added to the composition to prevent separation of the composition components by keeping ingredients dispersed. Emulsifiers can include molecules which have both a hydrophilic part and a hydrophobic part. Emulsifiers can operate at the interface between hydrophilic and hydrophobic materials of the beverage to prevent separation of the components of the composition. Suitable emulsifiers for use in the compositions include, for example, lecithin (e.g., soy lecithin); mono and di-glycerides of long chain fatty acids, specifically saturated fatty acids, and more specifically, stearic and palmitic acid mono- and diglycerides; mono and di-glycerides of acetic acid, citric acid, tartaric acid, or lactic acid; egg yolks; polysorbates (e.g., polysorbate 20, polysorbate 40, polysorbate 60, polysorbate 65, and polysorbate 80), propylene glycol esters (e.g, propylene glycol monostearate); propylene glycol esters of fatty acids; sorbitan esters (e.g., sorbitan monostearates, sorbitan tristearates, sorbitan monolaurate, sorbitan monooleate), Acacia (gum arabic), sucrose monoesters; polyglycerol esters; polyethoxylated glycerols; and the like, and a combination comprising at least one of the foregoing emulsifiers.

The composition can contain the emulsifier in an amount of about 0 to about 2.0, specifically about 0.05 to about 1.0, more specifically about 0.075 to about 0.75; and yet more specifically about 0. 10 to about 0.50 wt % each based on the total weight of the composition.

Certain components (sometimes referred to as hydrocolloids) that act as thickening agents which can impart added “mouth-feel” to the composition include natural and synthetic gums, for example locust bean gum, guar gum, gellan gum, xanthan gum, gum ghatti, modified gum ghatti, tragacanth gum, carrageenan, and the like; natural and modified starches, for example pregelatinized starch (corn, wheat, tapioca), pregelatinized high amylose-content starch, pregelatinized hydrolyzed starches (maltodextrins, corn syrup solids), chemically modified starches such as pregelatinized substituted starches (e.g., octenyl succinate), and the like; cellulose derivatives, for example carboxymethylcellulose, sodium carboxymethylcellulose, and the like; polydextrose; whey or whey protein concentrate; pectin; gelatin; and a combination comprising at least one of the foregoing thickening agents.

Preservatives, including antimicrobials, can be added to the composition to provide freshness and to prevent the unwanted growth of bacteria, molds, fungi, or yeast. The addition of a preservative, including antioxidants, may also be used to maintain the composition's color, flavor, or texture. Any suitable preservatives for use in food and beverage products can be incorporated into the compositions. Examples of suitable preservatives include benzoic acid alkali metal salts (e.g., sodium benzoate), sorbic acid alkali metal salts (e.g., potassium sorbate), ascorbic acid (Vitamin C), citric acid, calcium propionate, sodium erythorbate, sodium nitrite, calcium sorbate, butylated hydroxyanisole (BHA), butylated hydroxytoluene (BHT), ethylenediaminetetraacetic acid (EDTA), tocopherols (Vitamin E), straight chain polyphosphates, and a combination comprising at least one of the foregoing preservatives.

The composition can contain the preservative or preservative combination in an amount of about 0.01 to about 0.50, specifically about 0.02 to about 0.30, more specifically about 0.03 to about 0.10; and yet more specifically about 0.05 to about 0.08 wt % each based on the total weight of the composition.

The composition can be fortified or enriched with vitamins, minerals, micronutrients, or other nutrients. The sports beverage composition can comprise Vitamin C (optionally in the form of a salt) in the range of about 0.0005 to about 1.00 weight percent of the total beverage composition for use as an antioxidant for preventing free radical formation during exercise. The sports beverage composition can further comprise Vitamin E in the range of about 0.005 to about 0.01 weight percent of beverage composition for use as an antioxidant for preventing free radical formation during exercise.

Micronutrients can include materials that have an impact on the nutritional well being of an organism even though the quantity required by the organism to have the desired effect is small relative to macronutrients, such as protein, carbohydrate, and fat. Micronutrients can include, for example, vitamins, minerals, enzymes, phytochemicals, antioxidants, and a combination comprising at least one of the foregoing.

Suitable vitamins or vitamin precursors include ascorbic acid (Vitamin C), beta carotene, niacin (Vitamin B₃), riboflavin (Vitamin B₂), thiamin (Vitamin B₁), niacinamide, folate or folic acid, alpha tocopherols or esters thereof, Vitamin D, retinyl acetate, retinyl palmitate, pyridoxine (Vitamine B₆), folic acid (Vitamin B₉), cyanocobalimin (Vitamin B₁₂), pantothenic acid, biotin, and a combination comprising at least one of the foregoing vitamins.

In some embodiments, vitamins or vitamin precursors can include fat soluble vitamins such as vitamin A, vitamin D, vitamin E, and vitamin K, and a combination comprising at least one of the foregoing vitamins. In some embodiments, vitamins or vitamin precursors can include water soluble vitamins such as vitamin C (ascorbic acid), the B vitamins (thiamine or B₁, riboflavoin or B₂, niacin or B₃, pyridoxine or B₆, folic acid or B₉, cyanocobalimin or B₁₂, pantothenic acid, biotin), and a combination comprising at least one of the foregoing vitamins.

Exemplary minerals include sodium, magnesium, chromium, iodine, iron, manganese, calcium, copper, fluoride, potassium, phosphorous, molybdenum, selenium, zinc, and a combination comprising at least one of the foregoing minerals. The minerals can be provided as a mineral salt, including carbonate, oxide, hydroxide, chloride, sulfate, phosphate, pyrophosphate, gluconate, lactate, acetate, fumarate, citrate, malate, amino acids and the like for the cationic minerals and sodium, potassium, calcium, magnesium and the like for the anionic minerals.

The amount of vitamins or minerals provided in the compositions can be up to or exceeding amounts generally recognized as U.S. Recommended Daily amounts or the Recommended Daily Intake amounts established by the U.S. Food and Drug Administration.

In some embodiments exemplary micronutrients can include L-carnitine, choline, coenzyme Q10, alpha-lipoic acid, omega-3-fatty acids, pepsin, phytase, trypsin, lipases, proteases, cellulases, and a combination comprising at least one of the foregoing micronutrients.

Antioxidants can include materials that scavenge free radicals. In some embodiments, exemplary antioxidants can include citric acid, rosemary oil, vitamin A, vitamin E, vitamin E phosphate, tocopherols, di-alpha-tocopheryl phosphate, tocotrienols, alpha lipoic acid, dihydrolipoic acid, xanthophylls, beta cryptoxanthin, lycopene, lutein, zeaxanthin, astaxanthin, beta-carotene, carotenes, mixed carotenoids, polyphenols, flavonoids, and a combination comprising at least one of the foregoing antioxidants.

Exemplary nutrients can also include amino acids such as L-tryptophan, L-lysine, L-leucine, L-methionine, 2-aminoethanesulfonic acid (taurine), and L-carnitine; creatine; glucuronolactone; inositol; and a combination comprising at least one of the foregoing nutrients.

Phytochemicals (“phytonutrients”) are plant derived compounds which may provide a beneficial effect on the health or well-being of the consumer. Phytochemicals include plant derived antioxidants, phenolic compounds including monophenols and polyphenols, and the like. Exemplary phytochemicals include lutein, lycopene, carotene, anthocyanin, capsaicinoids, flavonoids, hydroxycinnamic acids, isoflavones, isothiocyanates, monoterpenes, chalcones, coumestans, dihydroflavonols, flavanoids, flavanols, quercetin, flavanones, flavones, flavan-3-ols (catechins, epicatechin, epigallocatechin, epigallocatechingallate, and the like), flavonals (anthocyanins, cyanidine, and the like); phenolic acids; phytosterols, saponins, terpenes (carotenoids), and a combination comprising at least one of the foregoing phytochemicals.

The phytochemicals can be provided in substantially pure or isolated form or in the form of natural plant extracts. Suitable plant extracts which contain one or more phytochemicals include fruit skin extracts (grape, apple, crab apple, and the like), green tea extracts, white tea extracts, green coffee extract, and a combination comprising at least one of the foregoing extracts.

Various herbals, aromatic plants or plant parts or extracts thereof, can also be included in the compositions for a variety of reasons such as for flavor or for their potential health benefits. Exemplary herbals include Echinacea, Goldenseal, Calendula, Rosemary, Thyme, Kava Kava, Aloe, Blood Root, Grapefruit Seed Extract, Black Cohosh, Ginseng, Guarana, Cranberry, Ginko Biloba, St. John's Wort, Evening Primrose Oil, Yohimbe Bark, Green Tea, Ma Huang, Maca, Bilberry, extracts thereof, and a combination comprising at least one of the foregoing herbals.

In one embodiment, the sports beverage composition can have a Brix measurement as measured by a Brix refractometer at 20° C. of about 8.0 to about 9.5° Brix, specifically about 8.5 to about 8.9° Brix.

In another embodiment, the sports beverage composition can have a Brix measurement as measured by a Brix densitometer at 20° C. of about 7.5 to about 9.1° Brix, specifically about 7.9 to about 8.3° Brix.

In one embodiment, the sport beverage composition contains about 1.0:1.0 to about 3.0:1.0 ratio of total carbohydrates to total protein, specifically about 1.5:1.0 to about 2.5:1.0, and yet more specifically about 2.0:1.0 to about 2.2:1.0. The carbohydrate can be a sweetening agent (e.g., invert sugar), a flavor potentiator (e.g., trehalose), or another component of the beverage.

Another approach to improve the organoleptic properties of the sports beverage composition includes use of a high-intensity sweetener to provide a lingering sweetness to help mask the dry mouthfeel and dairy/sulfur off-notes of the whey protein.

Another approach is to include “sensates”, trigeminal nerve stimulants which can alter the taste of the beverage composition and decrease the perception of off-notes. Sensates include “warming agents”, compounds which provide a sensation of warmth; “cooling agents”, compounds which provide a cooling sensation; and “tingling agents”, compounds which provide a tingling, stinging or numbing sensation.

The sensate may be a warming, a cooling, a tingling agent, or any combination comprising at least one of the foregoing sensates.

Warming agents may be selected from a wide variety of compounds known to provide the sensory signal of warming to the individual user. These compounds offer the perceived sensation of warmth, particularly in the oral cavity, and often enhance the perception of flavors, sweeteners and other organoleptic components. Useful warming agents include those having at least one allyl vinyl component, which may bind to oral receptors. Examples of suitable warming agents include vanillyl alcohol n-butylether (TK-1000, supplied by Takasago Perfumery Company Ltd., Tokyo, Japan); vanillyl alcohol n-propylether; vanillyl alcohol isopropylether; vanillyl alcohol isobutylether; vanillyl alcohol n-aminoether; vanillyl alcohol isoamylether; vanillyl alcohol n-hexylether; vanillyl alcohol methylether; vanillyl alcohol ethylether; gingerol; shogaol; paradol; zingerone; capsaicin; dihydrocapsaicin; nordihydrocapsaicin; homocapsaicin; homodihydrocapsaicin; ethanol; isopropyl alcohol; iso-amylalcohol; benzyl alcohol; glycerine; chloroform; eugenol; cinnamon oil; cinnamic aldehyde; phosphate derivatives thereof, and the like, or a combination comprising at least one of the foregoing warming sensates.

A variety of well-known cooling agents may be employed in the sports beverage composition. Exemplary cooling agents include menthol, xylitol, erythritol, menthane, menthone, menthyl acetate, menthyl salicylate, N,2,3-trimethyl-2-isopropyl butanamide (WS-23), N-ethyl-p-menthane-3-carboxamide (WS-3), menthyl succinate, 3,1-menthoxypropane 1,2-diol and glutarate esters, among others, and the like, or a combination comprising at least one of the foregoing cooling sensates.

Tingling agents may be employed in the beverage compositions to provide a tingling, stinging or numbing sensation to the user. Exemplary tingling agents include Jambu Oleoresin or para cress (Spilanthes sp.), in which the active ingredient is Spilanthol; Japanese pepper extract (Zanthoxylum peperitum), including the ingredients known as Saanshool-I, Saanshool-II and Sanshoamide; black pepper extract (piper nigrum), including the active ingredients chavicine and piperine; Echinacea extract; Northern Prickly Ash extract; red pepper oleoresin; and the like, or a combination comprising at least one of the foregoing tingling sensates.

The sensate may be present in the sports beverage composition in an amount of about 0.01 to about 10 weight percent, specifically about 0.1 to about 5.0, and yet more specifically about 1.0 to about 3.0 weight percent based on the total weight of the beverage composition.

Still yet another approach is the use of encapsulation technology to allow for the protein to be ingested, but not tasted by the consumer. The protein may be encapsulated, agglomerated, absorbed, entrapped, or extruded with an encapsulating agent. Any standard technique which gives partial or full encapsulation, can be used. These techniques include, but are not limited to, spray drying, spray chilling, fluid-bed coating, and coacervation. These encapsulation techniques can be used individually or in any combination in a single step process or multiple step process.

The encapsulation techniques that can be used can give varying degrees of coating from partial to full coating depending on the coating composition used in the process.

Encapsulant materials can be selected based on the desired properties of the encapsulated protein. For example, two standard food grade coating materials that are good film formers, but not water soluble, are shellac and Zein. Others which are more water soluble, but also good film formers, are materials such as agar, alginates, a wide range of cellulose derivatives like ethyl cellulose and hydroxpropylmethyl cellulose, dextrin, gelatin and modified starches. Other encapsulants like acacia or maltodextrin can also be used.

Generally, the higher the level of coating and the lower the amount of protein contained in the encapsulation product, the higher the degree of taste masking. To obtain the desired encapsulation, the encapsulant is at a minimum of about 20% of the coated product. Specifically, the encapsulant is at a minimum of about 30% of the coated product, and more specifically at a minimum of about 40% of the coated product. Depending on the coating material, a higher or lower amount of coating material may be used to provide the desired encapsulation.

Another method of partial encapsulation is agglomeration with an agglomerating agent which partially coats the protein. This method includes the step of mixing the protein and agglomerating agent with a small amount of water or solvent. The mixture is prepared in such a way as to have individual wet particles in contact with each other so a partial coating can be applied. After the water or solvent is removed, the mixture is ground and used as a powdered coated encapsulated protein.

Materials that can be used as the agglomerating agent are the same as those used in the encapsulation previously mentioned. However, since the coating is only a partial encapsulation, some agglomeration agents are more effective than others. These agglomerating agents include, but are not limited to, agar, alginates, a wide range of cellulose derivatives, dextrin, gelatin, modified starches, and vegetable gums such as guar gums, locust bean gum, and carrageenan.

Even though the agglomerated protein is only partially coated, when the quantity of coating is increased compared to the quantity of protein, improved protein taste masking is obtained. The level of coating used in the agglomerated product is at a minimum about 5%, specifically at a minimum of about 15%, and more specifically about 20%.

Protein maybe coated in a two-step process or multiple step process. Protein maybe encapsulated with any of the materials previously described and then the encapsulated material can be agglomerated as previously described to obtain an encapsulated/agglomerated product that could be used in a sports beverage to improve taste masking.

In another embodiment, protein may be absorbed onto another component, often referred to as a carrier, which is porous and becomes entrapped in the matrix of the porous component. Materials that can be used for absorbing protein include, but are not limited to, silicas, silicates, pharmasorb clay, sponge-like beads or microbeads, nanomaterials such as nanoclays, amorphous carbonates and hydroxides, including aluminum and calcium lakes, vegetable gums and other spray dried materials.

Depending on the type of absorbent material and how it is prepared, the amount of protein that can be loaded onto the absorbent will vary. Generally materials such as polymers or sponge-like beads or microbeads, amorphous sugars, and alditols and amorphous carbonates and hydroxides absorb about 10% to about 40% of the weight of the absorbent. Other materials such as silicas and pharmasorb clays may be able to absorb about 20% to about 80% of the weight of the absorbent.

The general procedure for absorbing protein onto the absorbent is as follows: an absorbent, such as fumed silica powder, can be mixed in a powder blender and a solution of protein can be sprayed onto the powder as the mixing continues. The aqueous solution can be about 5% to 10% protein; higher levels may be used if higher temperatures up to the denaturation temperature of the protein are used. Generally water is the solvent, but other solvents such as alcohol could be used if approved for use in food. As the powder mixes, the liquid is sprayed onto the powder. Spraying is stopped before the mix becomes damp. The still flowing powder is removed from the mixer and dried to remove the water or other solvent, then ground to a specific particle size.

After protein is absorbed onto an absorbent or fixed onto an absorbent, the fixative/protein can be coated by encapsulation. Either full or partial encapsulation may be used, depending on the coating composition used in the process. Full encapsulation may be obtained by coating with a polymer as in spray drying, spray chilling, fluid-bed coating, extrusion, coacervation, or any other standard technique. A partial encapsulation or coating can be obtained by agglomeration using any of the materials discussed above.

Thus, the four methods that can be used to obtain a taste masked protein are: (1) encapsulation by spray drying, fluid-bed coating, spray chilling and coacervation to give full or partial encapsulation; (2) agglomeration to give partial encapsulation; (3) fixation or absorption which also gives partial encapsulation; and (4) entrapment by extrusion. These four methods can be combined in any usable manner.

In some embodiments, the beverage composition is subject to homogenization conditions, such as high pressure homogenization, to provide a homogenous composition. The beverage component used to prepare a beverage composition or concentrate composition can be homogenized alone, or alternatively, juice and other components can be homogenized together to form a homogenized beverage composition or homogenized concentrate composition.

High pressure homogenization can be used and in some embodiments, juice solids are mashed under pressure. In general, homogenization processes alter the size and distribution of the fruit or vegetable pulp particles. More specifically, homogenization may break down and uniformly distribute the lipophilic components, the fruit or vegetable pulp particles, etc. throughout the composition. In addition, homogenization may modify the fruit or vegetable fibers found in the composition by reducing the length and fraying the ends of the fibrous materials. This may allow the fiber strands to absorb more liquid. Overall, homogenization may produce a more uniform composition having increased viscosity. Homogenization accordingly may impart a smoother mouthfeel to the composition.

In some embodiments, homogenization pressures of about 1000 pounds per square inch (psi) to about 4000 psi is used. Any conventional homogenization equipment can be employed, such as equipment available from APV Gaulin, Alfa-Laval or Niro Soavi.

Alternatively, in some embodiments, the beverage composition is hot-filled into the desired beverage container. More specifically, the beverage composition is filled into the beverage container at temperatures sufficient to sterilize the composition in the container, for example about 85° C. After several minutes, the container and composition can be cooled down to about 32 to about 38° C.

In other embodiments, the beverage composition is cold-filled into a desired beverage container. In such embodiments, preservatives can be added to the beverage composition. More specifically, cold-filling the beverage involves adding the beverage to the beverage container at ambient temperature (e.g., about 21° C.). Preservatives, such as those described herein, can be added to the composition to lower the pH level of the composition. Desirable pH values can be about 3 to about 4.5. Cold-filling with preservatives is used in some embodiments as an alternative to pasteurization.

In some embodiments, aseptic processes can be used to provide shelf stable, sterile beverages without the use of preservatives. The aseptic process involves sterilizing the beverage composition using an ultra-high temperature process that rapidly heats, then cools, the beverage composition. The time for sterilization can be about 3 to about 15 seconds at temperatures of about 195° F. (90.6° C.) to about 285° F. (140.6° C.). The sterilized beverage composition is then filled into sterilized aseptic packages within a sterile environment. Exemplary aseptic packages include a laminated container prepared from paperboard, polyethylene, e.g., low-density polyethylene (innermost layer), and aluminum; high density polyethylene (HDPE) plastic bottles; and the like.

The beverage compositions can be packaged, ready-to-drink, and can be shelf stable. Any type of beverage packaging can be used to package the beverage composition including glass bottles, plastic bottles and containers (e.g., polyethylene terephthalate or foil lined ethylene vinyl alcohol), metal cans (e.g., coated aluminum or steel), lined cardboard containers, and the like. Other beverage packaging material known to one of ordinary skill in the art can be used.

The features and advantages are more fully shown by the following examples which are provided for purposes of illustration, and are not to be construed as limiting the invention in any way.

### EXAMPLES

### Example 1

### Sports Beverage Composition Base Having Reduced Lactic Acid

Two base mixtures of a sports beverage composition without a flavoring agent or coloring agent is provided in Table 1 below wherein the amounts are in percent weight by weight. The micronutrients, electrolytes, and organic acid include magnesium carbonate, monopotassium phosphate, sodium chloride, sodium ascorbate, Vitamin E Acetate, and citric acid.

TABLE 1

| | A | B |
|---|---|---|
| Component | % wt/wt | % wt/wt |
| Reverse osmosis water | 85-96 | 88-92 |
| Medium Invert sugar (76.5° Brix) | 3.0-8.0 | 5.0-6.0 |
| Whey protein isolate | 1.0-3.5 | 1.3-1.8 |
| Trehalose | 1.0-3.0 | 1.5-2.3 |
| Micronutrients, electrolytes, | 0.15-0.7 | 0.3-0.5 |
| organic acid | | |
| Phosphoric Acid, 85% | 0.05-0.4 | 0.1-0.3 |
| Lactic Acid, 88% to pH 3.4 | 0.001-0.008 | 0.002-0.006 |
| Total | 100 | 100 |

The calculated density of the sports drink base B is 1.0296 kg/l. The base can be prepared into ready to drink beverages by the addition of a flavoring agent, a flavor masking agent, or coloring agent.

### Example 2

### Sports Beverage Composition Having Reduced Lactic Acid and Grapefruit Characteristic Flavor With Orange Notes

A sports beverage composition is prepared containing grapefruit characteristic flavor with orange notes. The components are provided in Table 2 below wherein the amounts are in percent weight by weight.

TABLE 2

| | % wt/wt |
|---|---|
| Component | |
| Reverse osmosis water | 88-92 |
| Medium Invert sugar (76.5° Brix) | 5.0-6.0 |
| Whey protein isolate | 1.3-1.8 |
| Trehalose | 1.5-2.3 |
| Micronutrients, electrolytes, organic acid | 0.3-0.5 |
| Phosphoric Acid, 85% | 0.1-0.3 |
| Lactic Acid, 88% to pH 3.4 | 0.001-0.200 |
| Tartrazine (FD&C Yellow 5) | 0.0001-0.0002 |
| Grapefruit-orange flavor | 0.15-0.19 |
| Bitter masking agent | 0.01-0.15 |
| Total | 100 |
| Product Characteristics | |
| Brix-Refractometer @20° C., ° Brix | 8.7 ± 0.2 |
| Brix-Densitometer @20° C., ° Brix | 8.1 ± 0.2 |
| Apparent density @20° C., kg/l | 1.0292 ± 0.0009 |
| Acidity as citric acid anhydrous, g/100 g | 0.49 ± 0.03 |
| Acidity as citric acid anhydrous, g/100 ml | 0.50 ± 0.03 |
| pH | 3.3 ± 0.2 |
| Color | Pale yellow |
| Appearance | Slightly cloudy |
| Aroma/flavor | Grapefruit/grapefruit |

The sports beverage is prepared by adding medium invert sugar to purified water with mixing. Magnesium carbonate, potassium phosphate, and sodium ascorbate are then added with mixing. A preblend of sodium chloride and vitamin E acetate is then added with mixing. The whey protein isolate/trehalose mixture is added to the tank. In a separate tank, citric acid is dissolved in an amount of water, then phosphoric acid and lactic acid is added to the citric acid mixture. The resulting acid solution is added to the first tank with stirring. A solution of tartrazine, the flavoring agent, and bitter masking agent are added to the first tank with stirring. The resulting beverage is tested for the characteristics disclosed in Table 2.

The beverage exhibits no dry mouthfeel and no sulfur/sour milk notes due to the reduced amounts of lactic acid and addition of the orange flavor note. Furthermore, the use of the grapefruit flavor imparts a complementary flavor to any sulfur notes imparted by the whey protein isolate as grapefruit flavor itself has sulfur notes. The product maintained the desired tartness with the use of phosphoric acid even though the lactic acid amount was reduced.

### Example 3

### Sports Beverage Composition Having Reduced Lactic Acid and Fruit Punch Characteristic Flavor With Orange Notes

A sports beverage composition is prepared containing fruit punch characteristic flavor with orange notes. The components are provided in Table 3 below wherein the amounts are in percent weight by weight.

TABLE 3

| | % wt/wt |
|---|---|
| Component | |
| Reverse osmosis water | 88-92 |
| Medium Invert sugar (76.5° Brix) | 5.0-6.0 |
| Whey protein isolate | 1.3-1.8 |
| Trehalose | 1.5-2.3 |
| Micronutrients, electrolytes, organic acid | 0.3-0.5 |
| Phosphoric Acid, 85% | 0.1-0.3 |
| Lactic Acid, 88% to pH 3.4 | 0.001-0.200 |
| FD&C red 40 solution | 0.01-0.03 |
| Fruit punch flavor | 0.05-0.3 |
| Orange flavor | 0.01-0.03 |
| Bitter masking agent | 0.01-0.15 |
| Total | 100 |
| Product Characteristics | |
| Brix-Refractometer @20° C., ° Brix | 8.7 ± 0.2 |
| Brix-Densitometer @20° C., ° Brix | 8.0 ± 0.2 |
| Apparent density @20° C., kg/l | 1.0290 ± 0.0009 |
| Acidity as citric acid anhydrous, g/100 g | 0.49 ± 0.03 |
| Acidity as citric acid anhydrous, g/100 ml | 0.50 ± 0.03 |
| pH | 3.3 ± 0.2 |
| Color | Red |
| Appearance | Slightly cloudy |
| Aroma/flavor | Fruit punch/fruit punch |

The sports beverage is prepared according to the process described in Example 2 above.

The beverage exhibits no dry mouthfeel and no sulfur/sour milk notes due to the reduced amounts of lactic acid and addition of the orange flavor note. The product maintained the desired tartness with the use of phosphoric acid.

### Example 4

### Sports Beverage Composition Having Reduced Lactic Acid and Dark Berry Flavor

A sports beverage composition is prepared containing a dark berry characteristic flavor. The components are provided in Table 4 below wherein the amounts are in percent weight by weight.

TABLE 4

| | % wt/wt |
|---|---|
| Component | |
| Reverse osmosis water | 88-92 |
| Medium Invert sugar (76.5° Brix) | 5.0-6.0 |
| Whey protein isolate | 1.3-1.8 |
| Trehalose | 1.5-2.3 |
| Micronutrients, electrolytes, organic acid | 0.3-0.5 |
| Phosphoric Acid, 85% | 0.1-0.3 |
| Lactic Acid, 88% to pH 3.4 | 0.001-0.200 |
| FD&C blue 1 solution | 0.005-0.01 |
| Berry flavor | 0.05-0.2 |
| Grape flavor | 0.04-0.08 |
| Bitter masking agent | 0.02-0.06 |
| Total | 100 |
| Product Characteristics | |
| Brix-Refractometer @20° C., ° Brix | 8.7 ± 0.2 |
| Brix-Densitometer @20° C., ° Brix | 8.1 ± 0.2 |
| Apparent density @20° C., kg/l | 1.0293 ± 0.0009 |
| Acidity as citric acid anhydrous, g/100 g | 0.49 ± 0.03 |
| Acidity as citric acid anhydrous, g/100 ml | 0.51 ± 0.03 |
| pH | 3.3 ± 0.2 |
| Color | Medium blue |
| Appearance | Slightly cloudy |
| Aroma/flavor | Berry w/grape notes/ |
| | berry w/grape notes |

The sports beverage is prepared according to the process described in Example 2 above.

The beverage exhibits no dry mouthfeel and no sulfur/sour milk notes due to the reduced amounts of lactic acid. The product maintained the desired tartness with the use of phosphoric acid.

### Example 5

### Sports Beverage Composition Having Reduced Lactic Acid and Peach-mango Characteristic Flavor With Orange Notes

A sports beverage composition is prepared containing peach-mango characteristic flavor with orange notes. The components are provided in Table 5 below wherein the amounts are in percent weight by weight.

TABLE 5

| | % wt/wt |
|---|---|
| Component | |
| Reverse osmosis water | 88-92 |
| Medium Invert sugar (76.5° Brix) | 5.0-6.0 |
| Whey protein isolate | 1.3-1.8 |
| Trehalose | 1.5-2.3 |
| Micronutrients, electrolytes, organic acid | 0.3-0.5 |
| Phosphoric Acid, 85% | 0.1-0.3 |
| Lactic Acid, 88% to pH 3.4 | 0.001-0.200 |
| Sunset yellow (FD&C yellow 6) | 0.0005-0.001 |
| Peach flavor | 0.01-0.1 |
| Mango flavor | 0.005-0.02 |
| Orange flavor | 0.01-0.03 |
| Total | 100 |
| Product Characteristics | |
| Brix-Refractometer @20° C., ° Brix | 8.7 ± 0.2 |
| Brix-Densitometer @20° C., ° Brix | 8.1 ± 0.2 |
| Apparent density @20° C., kg/l | 1.0291 ± 0.0009 |
| Acidity as citric acid anhydrous, g/100 g | 0.49 ± 0.03 |
| Acidity as citric acid anhydrous, g/100 ml | 0.50 ± 0.03 |
| pH | 3.3 ± 0.2 |
| Color | Medium peach |
| Appearance | Slightly cloudy |
| Aroma/flavor | Peach-mango/peach-mango |

The sports beverage is prepared according to the process described in Example 2 above.

The beverage exhibits no dry mouthfeel and no sulfur/sour milk notes due to the reduced amounts of lactic acid and addition of the orange flavor. The product maintained the desired tartness with the use of phosphoric acid.

The terms “first,” “second,” and the like, “primary,” “secondary,” and the like, as used herein do not denote any order, quantity, or importance, but rather are used to distinguish one element from another.

The terms “a” and “an” do not denote a limitation of quantity, but rather denote the presence of at least one of the referenced item.

The term “or” means “and/or”. As used herein the transitional term “comprising,” (also “comprises,” etc.) which is synonymous with “including,”“containing,” or “characterized by,” is inclusive or open-ended and does not exclude additional, unrecited elements or method steps, regardless of its use in the preamble or the body of a claim.

The endpoints of all ranges directed to the same component or property are inclusive of the endpoint and independently combinable.

All patents and other references identified by number herein are incorporated by reference in their entirety.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A sports beverage composition, comprising:
water;
a saccharide sweetener;
about 1.0 to about 3.5 weight percent of a protein based on the total weight of the composition;
about 0.001 to about 0.200 weight percent lactic acid based on the total weight of the composition;
phosphoric acid; and
a flavoring agent.

2. The composition of claim 1, wherein the composition provides substantially no drying mouthfeel, dairy off-notes, or sulfur off-notes.

3. The composition of claim 1, wherein the protein is a meat protein, a dairy protein, a vegetable protein, an egg protein, a yeast protein, or a combination thereof.

4. The composition of claim 1, wherein the protein is calcium caseinate, sodium caseinate, whey protein, whey protein concentrate, whey protein isolate, whey protein hydrolyzate, demineralized whey protein, milk protein, casein hydrolyzate, or a combination thereof.

5. The composition of claim 1, wherein the protein is whey protein isolate.

6. The composition of claim 1, wherein the flavoring agent is a complementary character flavor to a dairy note or a sulfur note.

7. The composition of claim 1, wherein the flavoring agent has a character flavor of tropical fruit, grapefruit, dark berry, peach, or fruit punch.

8. The composition of claim 1, further comprising an orange flavor note.

9. The composition of claim 1, further comprising a dairy masking agent or a bitter masking agent.

10. The composition of claim 1, further comprising a micronutrient.

11. The composition of claim 1, further comprising Vitamin A and Vitamin E.

12. The composition of claim 1, further comprising an electrolyte.

13. The composition of claim 12, wherein the electrolyte is a salt of sodium, potassium, magnesium, chloride, or a combination thereof.

14. The composition of claim 1, wherein the composition is a ready to drink beverage.

15. The composition of claim 1, wherein the pH of the composition is equal to or below 3.5.

16. The composition of claim 1, wherein the titratable acidity is about 0.3 to about 0.7 g/100 g.

17. The composition of claim 1, wherein the composition exhibits about 8.0 to about 9.5° Brix as measured by a Brix refractometer at 20° C.; or exhibits about 7.5 to about 9.1° Brix as measured by a Brix densitometer at 20° C.

18. The composition of claim 1, further comprising a high-intensity sweetener.

19. The composition of claim 1, further comprising a sensate.

20. The composition of claim 1, wherein the protein is encapsulated for taste-masking.

21. A sports beverage composition, comprising:
water;
a saccharide sweetener;
about 1.0 to about 3.5 weight percent of a protein based on the total weight of the composition;
an orange flavor note; and
a flavoring agent.

22. The composition of claim 21, wherein the composition provides substantially no drying mouthfeel, dairy off-notes, or sulfur off-notes.

23. The composition of claim 21, wherein the protein is a meat protein, a dairy protein, a vegetable protein, an egg protein, a yeast protein, or a combination thereof.

24. The composition of claim 21, wherein the protein is calcium caseinate, sodium caseinate, whey protein, whey protein concentrate, whey protein isolate, whey protein hydrolyzate, demineralized whey protein, milk protein, casein hydrolyzate, or a combination thereof.

25. The composition of claim 21, wherein the protein is whey protein isolate.

26. The composition of claim 21, wherein the flavoring agent is a complementary character flavor to a dairy note or a sulfur note.

27. The composition of claim 21, wherein the flavoring agent has a character flavor of tropical fruit, grapefruit, dark berry, peach, or fruit punch.

28. The composition of claim 21, further comprising a dairy masking agent or a bitter masking agent.

29. The composition of claim 21, further comprising a micronutrient.

30. The composition of claim 21, further comprising Vitamin A and Vitamin E.

31. The composition of claim 21, further comprising an electrolyte.

32. The composition of claim 31, wherein the electrolyte is a salt of sodium, potassium, magnesium, chloride, or a combination thereof.

33. The composition of claim 21, wherein the composition is a ready to drink beverage.

34. The composition of claim 21, wherein the pH of the composition is equal to or below 3.5.

35. The composition of claim 21, wherein the titratable acidity is about 0.3 to about 0.7 g/100 g.

36. The composition of claim 21, wherein the composition exhibits about 8.0 to about 9.5° Brix as measured by a Brix refractometer at 20° C.; or exhibits about 7.5 to about 9.1° Brix as measured by a Brix densitometer at 20° C.

37. The composition of claim 21, further comprising a high-intensity sweetener.

38. The composition of claim 21, further comprising a sensate.

39. The composition of claim 21, wherein the protein is encapsulated for taste-masking.

40. A sports beverage composition, comprising:
water;
trehalose;
about 1.0 to about 3.5 weight percent of a whey protein isolate based on the total weight of the composition;
about 0.001 to about 0.200 weight percent lactic acid based on the total weight of the composition;
phosphoric acid;
optionally a flavoring agent further comprising an orange flavor note; and
optionally a dairy masking agent or a bitter masking agent.

41. A sports beverage composition, comprising:
water;
medium invert sugar;
trehalose;
about 1.0 to about 3.5 weight percent of a whey protein isolate based on the total weight of the composition;
about 0.001 to about 0.200 weight percent lactic acid based on the total weight of the composition;
phosphoric acid;
magnesium carbonate;
monopotassium phosphate;
sodium chloride;
citric acid;
sodium ascorbate;
vitamin E acetate; and
a flavoring agent having a character flavor of tropical fruit, grapefruit, dark berry, peach, or fruit punch;
optionally the flavoring agent further comprises an orange flavor note; and
optionally a dairy masking agent or a bitter masking agent.
